(19) United States
(12) Patent Application Publication
(10) Pub. No.: US 2005/0138062 A1
(43) Pub. Date: Jun. 23, 2005

(54) Method, computer program, apparatus and system for the selective communication of data sets

(75) Inventors: Max Egon Mergenthaler, Iphofen (DE); Jurgen Preuninger, Munich (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/999,809

(22) Filed: Nov. 29, 2004

(30) Foreign Application Priority Data
Nov. 28, 2003 (DE) 103 55 622.2
May 28, 2004 (DE) 10 2004 026 265.9

(51) Int. Cl. G06F 17/30

(52) U.S. Cl. 707/102

(57) ABSTRACT

Method for selectively communicating data sets. The method includes the steps of detecting at least one data set of a first user, the data set being communicated via an at least unidirectional connection, detecting at least one data set of at least one second user, comparing at least one part of the detected data sets, and if a matching result is been determined, communicating at least one part of the data set of the first user to the second user, and/or communicating at least one part of the data set of the second user to the first user. Also, a computer program, an apparatus, and a system for selectively communicating data sets.

### CROSS-REFERENCE TO RELATED APPLICATION

This application claims priority to German Patent Application Serial No. 103 55 622.2-53 filed Nov. 28, 2003, and German Patent Application Serial No. 10 2004 026 265.9 filed May 28, 2004, which are incorporated herein by reference in their entirety.

### FIELD OF THE INVENTION

The present invention relates to a method, a computer program, an apparatus and a system for the selective communication of data sets.

### BACKGROUND OF THE INVENTION

It is known to publish advertisements on the Internet. If a user would like to effect a specific transaction, e.g. a purchase or sale, he may search online for corresponding advertisements. However, this has the disadvantage that the user constantly has to follow the changes in the offers in order to find newly added advertisements. The consequence of this is that the user has to frequently log on to the respective Internet page, which results in a high expenditure of time for the user. Furthermore, it may happen that the user does not find a corresponding advertisement until at a later point in time and the transaction has already been effected by another user.

### SUMMARY OF THE INVENTION

Consequently, it is an object of the present invention to provide a method, an apparatus and a system for the selective communication of data sets which enable a simple, near-instantaneous and variable handling of transactions.

The invention provides a method for the selective communication or distribution of data sets, comprising the following steps:
detecting at least one data set of a first user, the data set being communicated via an at least unidirectional connection which is preferably interrupted after conclusion of the transmission;
detecting at least one data set of at least one second user;
comparing at least one part of the detected data sets; and
if a positive or matching result is determined, further comprising at least one of the following steps:
communicating at least one part of the at least one data set of the first user to the at least one second user; and
communicating at least one part of the at least one data set of the at least one second user to the first user.

The method according to the invention can thus be used to make it possible, essentially near-instantaneously, to transmit matching or mutually corresponding data sets from at least two users to in each case the other users.

Preferably, the method furthermore comprises a step of buffer storing or temporary storing the detected data sets.

Further preferably, the method furthermore comprises a step of processing the detected data sets.

The detected data sets may comprise non-dedicated and/or non-structured data. The data may, in particular, be combined in a file of a predeterminable format.

Preferably, the non-dedicated and/or non-structured data are represented in ASCII format, preferably in HTML format, for the comparing step. Consequently, the data are represented in a different way only for the comparison. The original structure of the data, e.g. the file format, is retained, however.

Preferably, the data sets are stored as a file in a known format, such as e.g. an email message (*.msg) with attached Powerpoint, Excel or Word document, etc. After detection, the information items contained in the files are preferably extracted from the files and processed further. In this case, it may be provided that in each case one data set is contained in one file or a plurality of data sets or enquiries in one file.

In a preferred embodiment, the step of communicating the data sets is effected by means of unified messaging.

In the sense of this invention, unified messaging is understood to be, in particular, a transmission of data or information items via email, SMS, fax or any other suitable type of communication of information or data. Moreover, any data transmission via known data interfaces such as IR, Bluetooth, COM, USB-PlugIn, Feedthrough card reader, etc. may be used. The communication of the data set to the user may preferably be effected via a different medium or a different path than the communication of a data set from the user.

Preferably, the method furthermore comprises a step of ascertaining the medium via which data sets are intended to be communicated to a specific user.

It may be provided that the data set detected by the user contains information items about the way in which the reply or a corresponding data set is intended to be communicated. As an alternative, it may be provided that the user communicates his preferred type of communication at an earlier point in time than the communication of data sets.

Preferably, the detected data sets have a temporally limited validity or, at the location of buffer storage and evaluation, the data set is provided with a time stamp and the method further comprises a step of checking the validity of a data set.

This makes it possible for a data set to be valid only for a specific time duration or for an enquiry to be active only over a specific time period. If the time duration of the validity of a data set has expired, this data set is preferably no longer taken into account during adjustment and is erased. The time duration of validity can thus be defined by the user or the system.

Preferably, the connection via which the data set of the first user is transmitted is interrupted after conclusion of the transmission.

Preferably, the at least one data set of the at least one second user is transmitted via an at least unidirectional connection which is preferably interrupted after conclusion of the communication.

Furthermore, it may be provided that the communication of the at least one part of the at least one data set of the first user to the second user is effected via an at least unidirectional connection which is preferably interrupted after conclusion of the transmission.

Moreover, the communication of the at least one part of the at least one data set of the at least one second user to the first user may be effected via an at least unidirectional connection which is preferably interrupted after conclusion of the transmission.

Consequently, it is not necessary for the first and/or the at least one second user to be continuously connected or “logged on” to the system. It is advantageous that a connection is set up only when a transmission of data to or from the user is to be effected.

In a preferred embodiment, at least one of the steps of detecting data sets comprises a step of detecting data sets of users from a geographically and/or virtually delimited area.

Preferably, the method furthermore comprises a step of determining the geographically delimited area with the aid of mobile radio cells.

This makes it possible for, preferably, data sets from a specific geographical region or a locally delimited area to be adjusted with one another and in each case be transmitted to the other user.

Preferably, at least one of the steps of detecting data sets comprises a step of reading-out of a storage medium of a user, the storage medium preferably being a mobile storage medium.

In particular, data or data sets or enquiries of the user are stored on the storage medium of the user.

Preferably, at least one of the detecting steps comprises a step of categorizing, in particular into at least two categories, of at least one part of the at lest one detected data set. In particular, the data sets may be categorized at least into offers and/or searches.

Furthermore, at least one of the detecting steps may comprise a step of identifying and/or authenticating the user. The identification and/or authentication may be effected by means of the user's telephone number, email address or the like.

Preferably, the method further comprises a step of communicating at least one part of a data set of a user to an external database.

Further preferably, the method furthermore comprises a step of storing at least one part of a data set of a user in a storage space that is ambiguously allocated to the user, preferably on the Internet.

Preferably, at least one of the detecting steps is effected if the user enters a predetermined area. It is thus possible to carry out a check whether a user is situated in the predetermined area.

Further preferably, at least one of the detecting steps is effected if the user leaves a predetermined area.

The invention further provides a computer program for the selective communication of data sets, which has program parts for carrying out a method according to the invention or a preferred embodiment thereof.

The invention furthermore provides an apparatus for the selective communication of data sets, comprising:
a detection device for detecting at least one data set of a first user and at least one data set of a second user;
an adjustment device for adjusting at least one part of the detected data sets;
a communication device for communicating at least parts of data sets to users, the communication device being designed in such a way that, if a positive/matching result is determined, it
communicates at least one part of the data set of the first user to the second user, and/or
communicates at least one part of the data set of the second user to the first user.

Preferably, the apparatus further comprises a storage device for buffer storing the detected data sets.

Preferably, the apparatus further comprises a processing device for processing the detected data sets.

The communication device is preferably designed for communication of the data sets by means of unified messaging or representing the comparison result on a large screen.

Further preferably, the apparatus further comprises a device for ascertaining the medium via which data sets are intended to be communicated to a specific user.

Moreover, the apparatus may further comprise a device for checking the validity of a data set.

The invention further provides a system for the selective communication of data sets, comprising:
an apparatus according to the invention or a preferred embodiment thereof;
at least two storage media on which data sets are stored and/or edited by users,
wherein data sets in each case are transmitted from a storage medium to the apparatus.

Preferably, the storage media are mobile storage media.

The invention further proposes the use of a system according to the invention or a preferred embodiment for the distribution of documents on an event, for the distribution of information in a network of persons and/or for communication between persons in a mass transportation means.

A further aspect of the invention provides a method for the selective communication of data sets, comprising the following steps:
making a data set available to a preferably locally or virtually delimited platform by a first and a second user;
comparing the data sets of the users in the platform;
if a matching result is determined, further comprising at least one of the following steps:
communicating at least one part of the data set of the first user to the second user; and
communicating at least one part of the data set of the second user to the first user.

Consequently, the method described above can be used to make it possible to ascertain two users with matching or complementary requirements and to exchange data sets between said users.

In particular, the present invention provides a method, a computer program, an apparatus and a system for selective content-dependent or content-sensitive data distribution.

### BRIEF DESCRIPTION OF THE DRAWINGS

Further features, objects and advantages of the present invention will become apparent from the detailed description of preferred embodiments of the present invention with reference to the drawings, in which:

FIG. 1 shows a schematic view of a system for the selective communication of data sets in accordance with a preferred embodiment of the present invention;

FIGS. 2A-G show so-called “screen shots” that each show parts of an input mask at the user end in accordance with a preferred embodiment of the invention;

FIG. 3 shows a flowchart of a sequence of the method in accordance with a preferred embodiment of the present invention;

FIG. 4 shows a partly schematic view of an apparatus in accordance with a preferred embodiment of the present invention;

FIG. 5 shows a schematic illustration of a possibility for application of the system and method in accordance with a preferred embodiment of the present invention;

FIG. 6 shows a flowchart showing a sequence of generating and uploading data sets at the user end;

FIGS. 7A-E show a flowchart showing the detailed sequence of steps S10 and S12 of FIG. 3;

FIG. 8 shows a flowchart showing the detailed sequence of steps S14 to S20 of FIG. 3;

FIG. 9 shows a flowchart showing the sequence of a further use of data sets; and

FIG. 10 shows a schematic view of a definition of a predetermined area by means of mobile radio cells.

### DETAILED DESCRIPTION OF PREFERRED EMBODIMENTS OF THE INVENTION

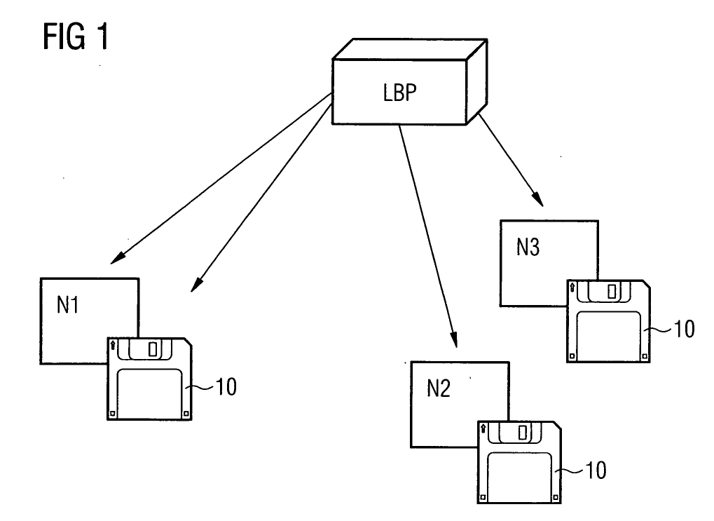

FIG. 1 shows a schematic view of a system for the selective communication of data sets in accordance with a preferred embodiment of the present invention.

A system in accordance with the preferred embodiment of the invention comprises at least one apparatus for the selective communication of data sets or a decision unit or a location based platform LBP and a plurality of storage media 10, at least two. FIG. 1 illustrates three storage media 10 by way of example. The storage media 10 are preferably in each case assigned to users N1, N2, N3 or are carried by the latter on their person.

The storage medium 10 is preferably a mobile storage medium on which data or data sets of a user can be stored. Such a storage medium 10 may be e.g. a USB memory stick with an optional antenna, a smart card with an optional antenna, a part of the memory of a mobile telephone or an area on the hard disk of a personal computer or a web space on the Internet which can preferably be accessed only by the user.

The location based platform LBP is preferably an apparatus which can receive or detect, process or condition, buffer-store data or data sets of a user, compare or adjust them with one another and can communicate at least parts of data sets to other users. In particular, at least parts of a data set of one user are communicated to another user via the location based platform. In FIG. 1, this is e.g. a communication of data between users N1 and N3.

It may be provided that a specific location based platform LBP utilizes in each case only data of users who are situated in a geographically or virtually delimited environment. The detailed sequence of the processing of data sets in the location based platform LBP is described later.

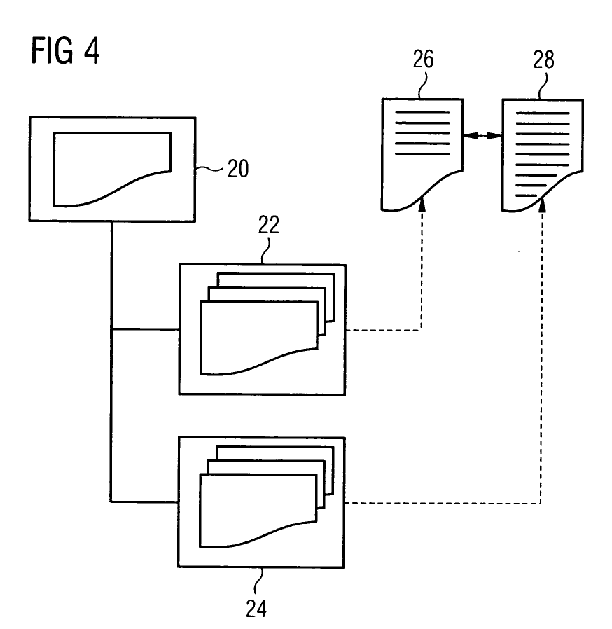

FIG. 4 shows a partly schematic view of a location based platform LBP in accordance with a preferred embodiment of the invention. The location based platform LBP comprises a detection device 20, a buffer storage device or pool for searches or search pool 22, a buffer storage device or pool for offers or offer pool 24, a list for searches or search list 26 and a list for offers or offer list 28.

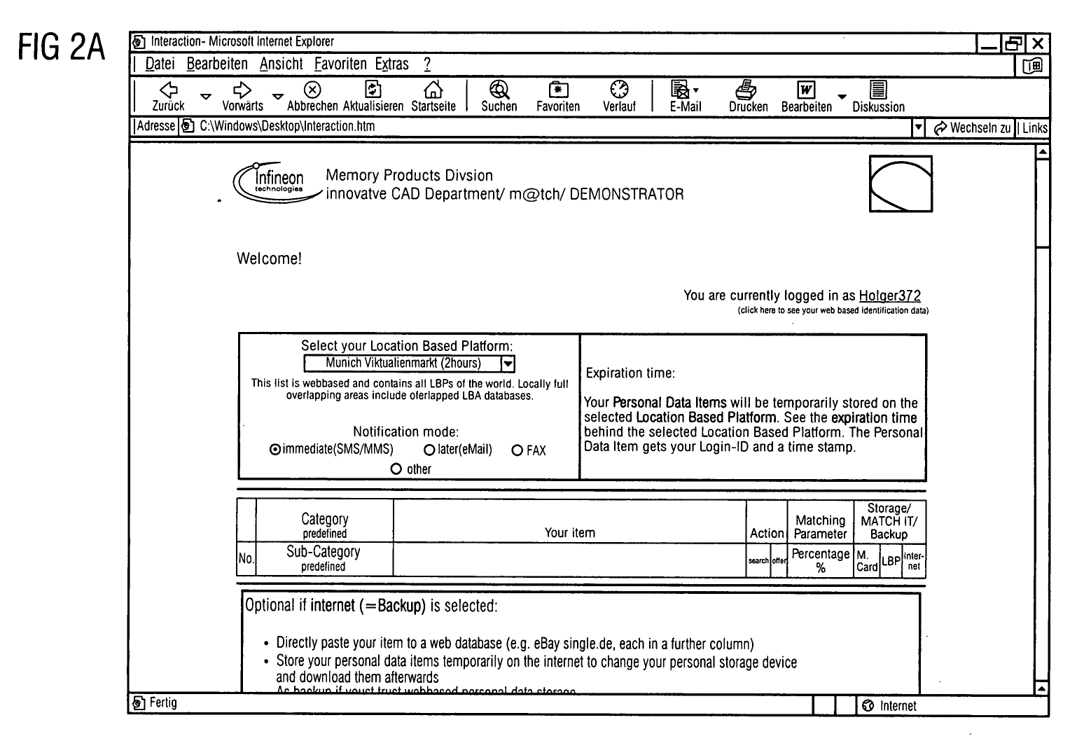

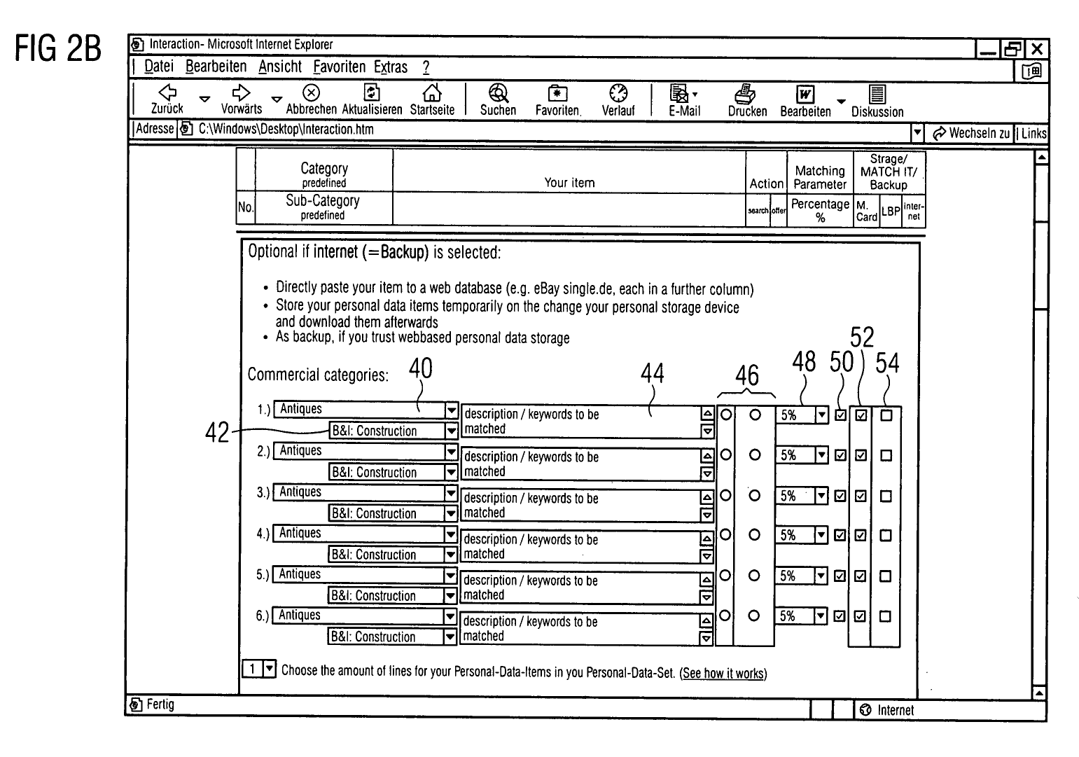

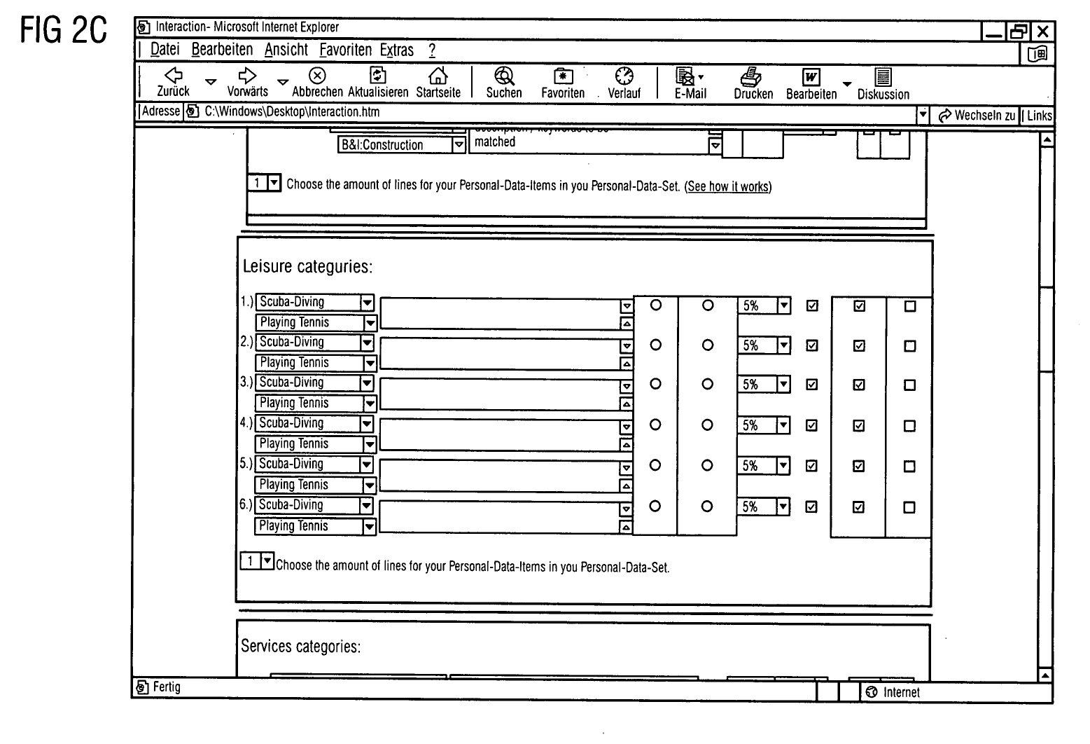

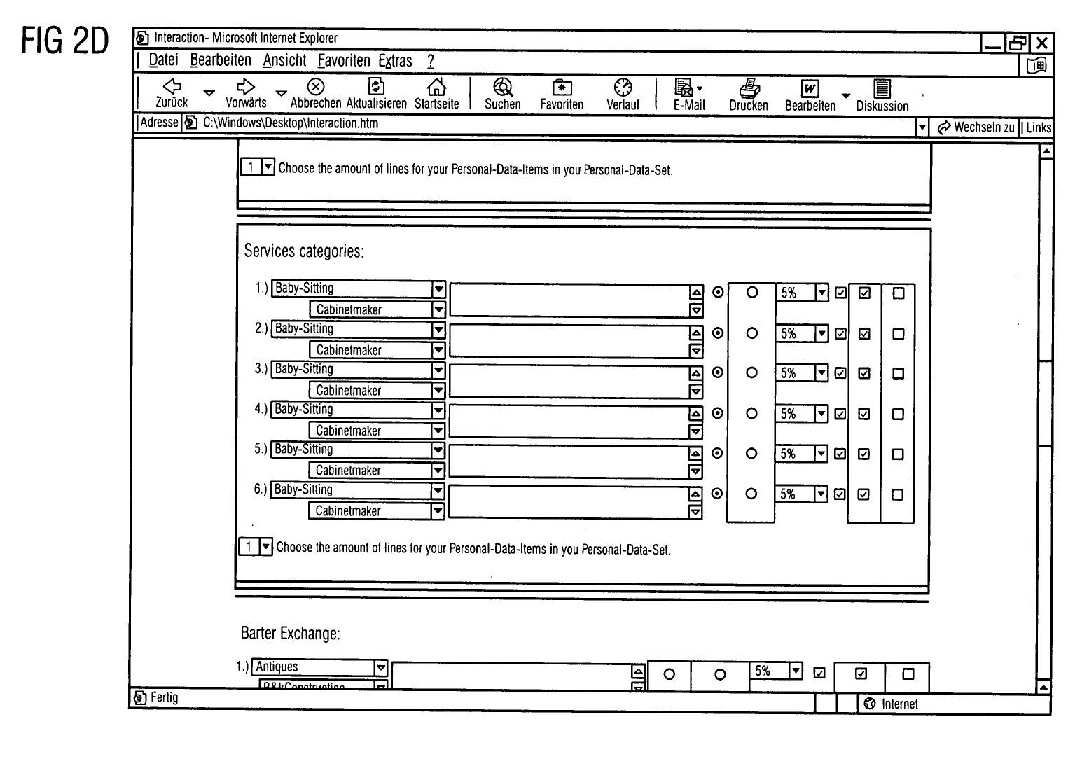

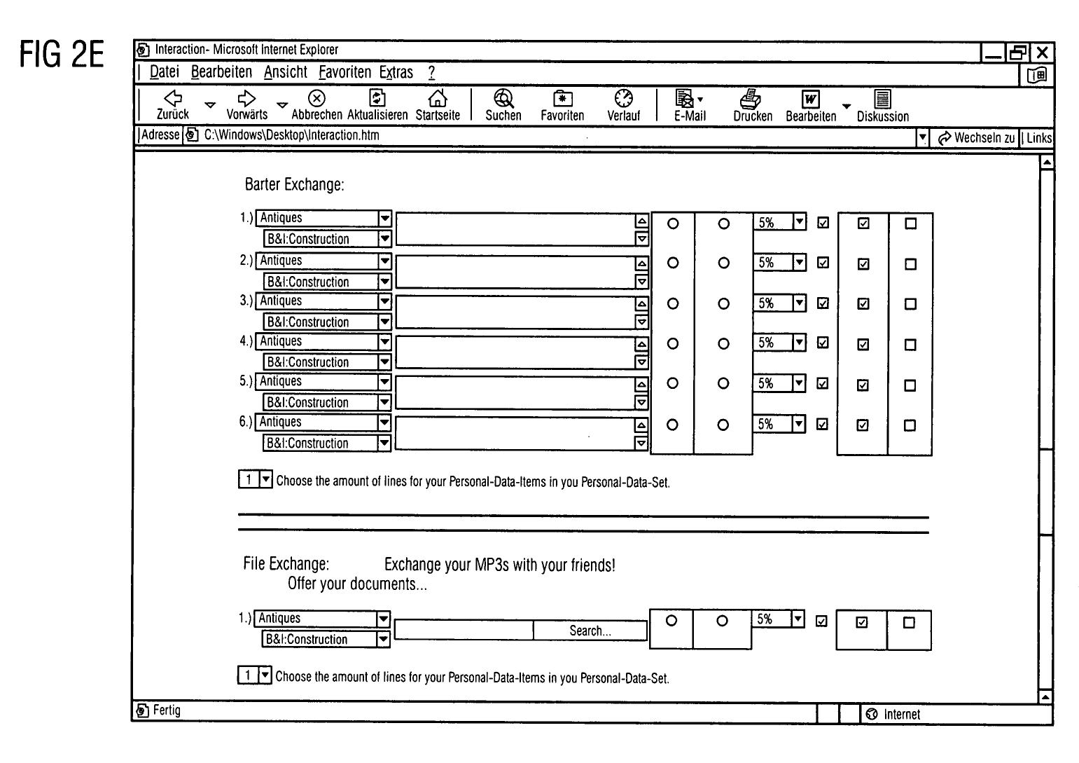

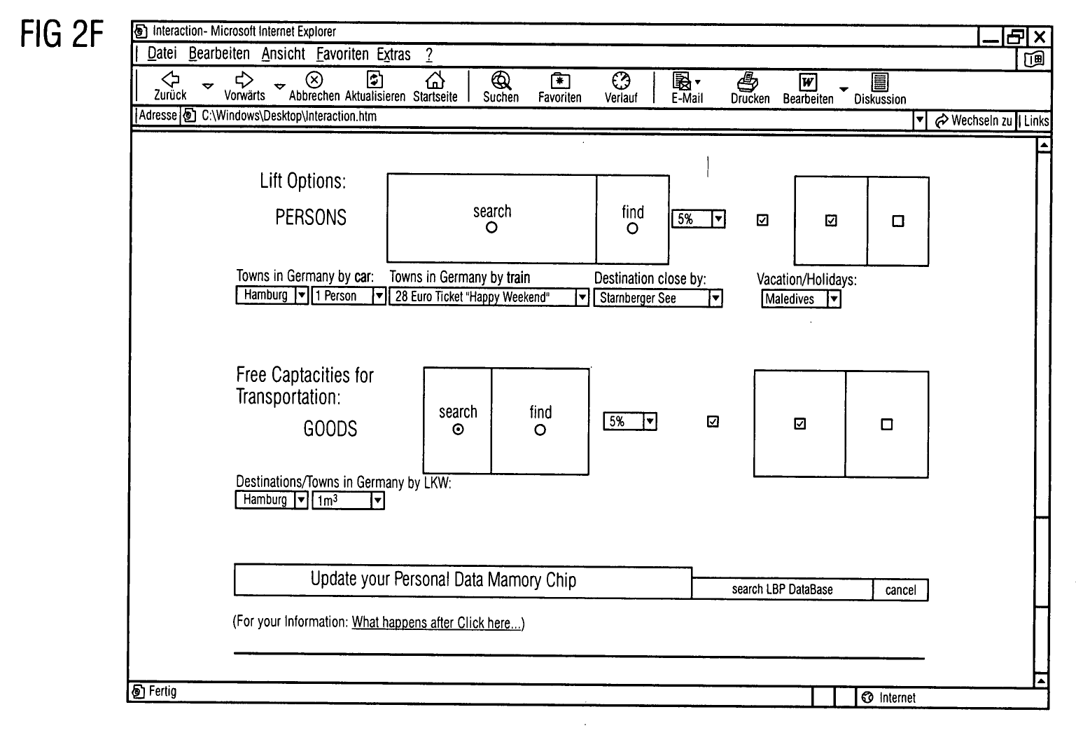

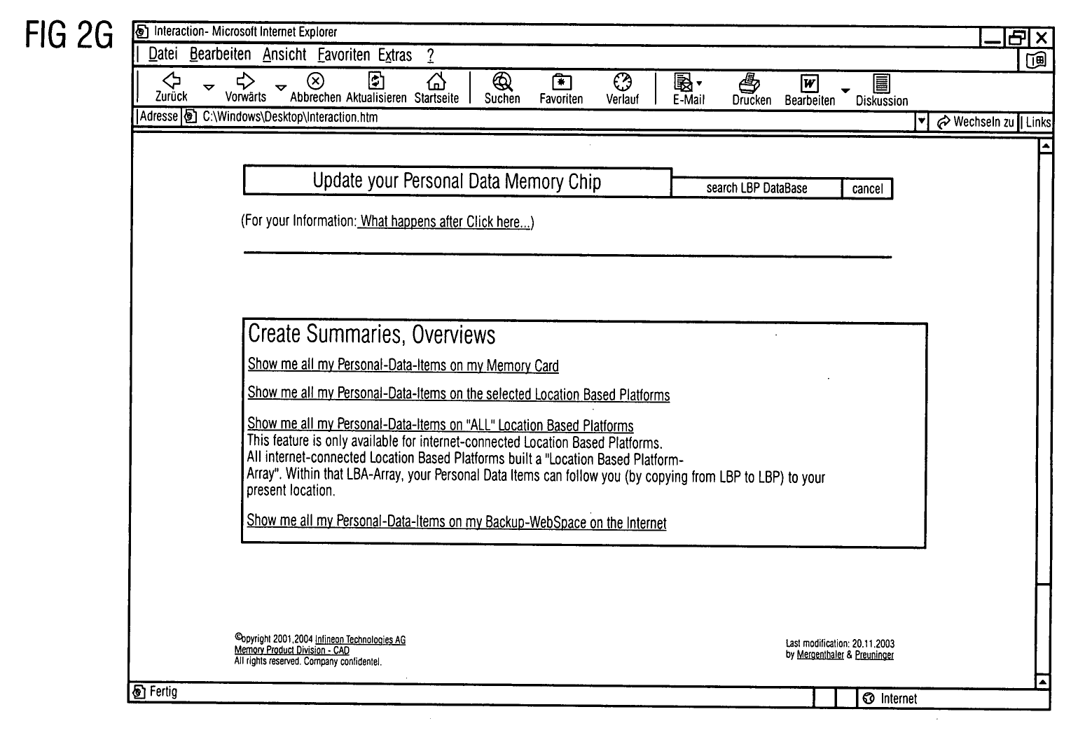

A detailed description is given below of the inputting of data or data sets from a user's standpoint with reference to FIGS. 2A-G. A user stores his profile, his requirements or searches and offers in the storage medium 10. The user's data or data sets may be stored e.g. with the aid of a computer, an electronic organizer or handheld or a mobile telephone.

FIGS. 2A-G show an input mask with the aid of which a user can input his desired data. The individual screen views or sections in FIGS. 2A-F preferably form a continuous document or a continuous view within which the user can move or scroll up and down.

In the view shown in FIG. 2A, the user can determine the geographical or virtual area in which his data are intended to be made available (“select your location based platform:”). In the example illustrated, the user's data are intended to be made available in Munich in the vicinity of the Viktualienmarkt (“Munich Viktualienmarkt”) as location based platform LBP.

In the embodiment illustrated in the present case, a selection of a specific location based platform LBP furthermore defines the intended period of validity of the data that are transmitted to the specific location based platform LBP, i.e. the time duration over which the respective data set is intended to be taken into account for an adjustment. In other words, in the embodiment illustrated, the time duration of the validity of all data sets that have been transmitted to a specific location based platform LBP is essentially identical, e.g. 2 hours or 1 day, . . . In the present case, the validity of the transmitted data is two hours (“2 hours”). The time duration of the validity is preferably defined by the location based platform LBP. As an alternative, it may be provided that the user can determine, by means of an additional input, how long the data or the data set are or is intended to be valid. An upper limit of the transmission delay is thus defined. The transmission delay is, in particular, time required for the transmission of the data from a first user to a matching partner. This time is influenced in particular by the time required until a matching of data sets is available in the location based platform LBP. The maximum of this time is essentially the upper limit above. The data sets of the user are temporarily stored during the time duration of the validity in the location based platform LBP. Preferably, the data set received in the location based platform LBP is allocated a user identification or user ID and a time stamp.

The user can determine how he would like to be notified of a match found (“notification mode”). In the present case, the user can choose to be notified immediately by SMS or MMS (“immediate (SMS/MMS)”) or later by email (“later (EMAIL)”). Furthermore, the user can choose to be notified by fax or in some other way (“other”). As an alternative, it may be provided that the user is notified via the same path or the same medium via which his data set was transmitted to the location based platform LBP.

Moreover, the user may choose from a multiplicity of categories in order to determine a profile, a search or an offer (“category”, “subcategory”, . . . ). Examples of corresponding categories are shown in FIGS. 2B-F and are described later.

The fields “search” and “offer” in the “action” area can be used to define whether an offer (“offer”) or a search (“search”) is present.

In addition, the user can define how high the degree of matching with another data set is intended to be if the user is notified (“matching parameter”). When a low percentage is specified, even a low degree of matching suffices to trigger a notification or communication of a data set to the user, whereas a high degree of matching has to be present when a high percentage is specified.

Furthermore, the user can define where or the location at which the data that he inputs are intended to be stored and when an adjustment is intended to be effected. In the example illustrated, the data may either be stored on a memory card locally with the user (“Storage” and “M. Card”). If the user selects the function “MATCH IT”/“LBP” by putting a check mark at the appropriate point, a transmission of the data is activated. Furthermore, the user can store his data in a storage space allocated to him on the Internet (“Backup”/“internet”) which can preferably be accessed only by the user, and can thus effect a kind of backup of his data. In this option, the user can furthermore and/or alternatively temporarily effect storage in a storage space on the Internet in order e.g. to exchange his storage medium. Afterward, these buffer-stored data can be loaded into the user's storage medium or memory chip again. Moreover, the user's data can be communicated directly via the Internet into a database available on the Internet, such as e.g. ebay.

A detailed description is given below, with reference to FIGS. 2B to 2G, of different categories or selection possibilities by means of which the user can formulate offers and/or searches.

In the screen shot shown in FIG. 2B, the user can choose from a multiplicity of commercial categories (“commercial categories”). In this case, a multiplicity of selection possibilities, such as e.g. antiques, art, books, clothing, collectors articles, . . . , are available to the user in a so-called “Pop-up menu” 40. The user can specify his search criteria further in the second Pop-up menu 42. In the input window 44, the user can input a description and/or keywords that are intended to be taken into account for the search or during the matching process in the location based platform LBP. In the area 46, the user can specify whether he would like to communicate a search or an offer. In the area 48, the user can specify how high the degree of matching is to be (“matching parameter” as described above). In the fields 50 to 54, the user can specify where his data are intended to be stored and whether the data are intended to be transmitted to a predetermined location based platform LBP. The detailed method of operation of these selection possibilities has already been described with reference to FIG. 2A.

The functionality of the areas 46 to 54 is essentially the same in the views shown in FIGS. 2B to 2F. For this reason, a detailed description is dispensed with below.

In the view shown in FIG. 2C, the user can choose from a multiplicity of leisure categories (“leisure categories”), such as e.g. scuba diving, playing tennis, . . . , in order to find other people with the same interests.

In the view shown in FIG. 2D, the user can choose from a multiplicity of services categories (“services categories”), such as e.g. babysitting, skilled manual activities, translations, . . . In this way, the user can find a person or persons who will perform these activities or the user can offer such services.

A barter exchange is made available in the view shown in FIG. 2E. In this case, in a similar manner to that in the figures described above, the user can choose from a multiplicity of categories in order to find a corresponding barter partner.

Moreover, as shown in the lower area of FIG. 2E, the user can exchange files, e.g. MP3 files, with other users.

In the view shown in FIG. 2F, the user can specify whether he would like to offer or is seeking a lift. In particular, it is possible to specify whether such a lift is offered or sought by car or train, to what German town the lift is offered or sought and for how many persons. Moreover, it is possible to specify a lift for recreational areas in the vicinity of the respective location based platform. Furthermore, it is also possible to select travel destinations.

In the second area shown in FIG. 2F, the user can choose to search for or offer free capacities for the transportation of goods (“free capacities for transportation”). In this case, it is possible to choose the intended destination of the transportation and how much free capacity, e.g. in cubic meters, is offered or searched for.

FIG. 2G is the final view of the Internet page. Here the user can choose whether his personal storage medium is to be changed or updated in accordance with the selection he has made (“update your personal data memory chip”), whether the data are intended to be communicated to a selected location based platform LBP (“search LBP database”) or whether the user would like to cancel the input (“cancel”).

Moreover, the user may generate overviews or summaries as required (“create summaries, overviews”). In this case, it is possible to display all personal data sets or personal data items on the user's storage medium, all personal data sets of the user in the selected location based platform LBP or all personal data sets of the user on all location based platforms LBP used by the user.

The last selection possibility is only available if the respective location based platform LBP has a connection to the Internet. In this case, all location based platforms LBP connected to the Internet form a so-called “location based platform array”. Within this LBP array, the personal data sets of the user can be copied from one location based platform to the next location based platform, depending on what area of what location based platform LBP the user is currently in. Moreover, there is a possibility of displaying the personal data sets which are stored in the memory on the Internet which is assigned to the user and serves as a backup.

Once the user has input all his desired data, the data are preferably stored on the user's memory chip and can subsequently be fed selectively to the selected location based platform LBP for evaluation.

As an alternative, it may be provided that the user stores non-dedicated and/or non-structured data on his storage medium. The data may be combined in particular in a file of a predeterminable format, e.g. MS word, MS excel, etc. In this case, the user's data are stored in a preferably arbitrary manner in the file, i.e. it is preferably not necessary to store or provide the data in a specific form or order.

In the present case, it is assumed hereinafter that the user stores his data on a memory card or a mobile storage medium 10.

The transmission of the data or data sets of a user to a selected location based platform LBP can be effected in various ways.

In one alternative, the transmission of the data from the user or the storage medium 10 to the location based platform LBP may be effected by means of transponder technology by the storage medium 10 being physically brought close to a read-in point. In this case, it is conceivable that the user can define whether a read-out is always to be effected automatically or only upon activation of this function.

Furthermore, the transmission can be effected by radio if the user is situated within a specific mobile radio cell and the storage medium 10 is integrated in a mobile telephone. In this case, too, it is conceivable that the user can define whether a read-out is always to be effected automatically or only upon activation of this function.

By way of example, a transmission may take place if the user moves physically into the geographical region of the selected location based platform LBP. This is particularly of interest if the user would like as far as possible to receive an acknowledgement while he is situated within the area of the location based platform LBP that he determined or selected. Consequently, the location based platform LBP to which the data are transmitted and the user's location are preferably essentially identical.

In another alternative, the data transmission can be carried out if the storage medium 10, e.g. a USB memory stick, is attached to a computer or e.g. a memory card is introduced into a memory card reader. Furthermore, it is conceivable for the data transmission to be effected by means of Bluetooth technology.

Alternatively, it is furthermore possible for the data to be transmitted to the selected location based platform LBP by SMS or email. In this case, the user may for example transmit his data to a location based platform LBP which is of interest to him. This location based platform LBP may be a location based platform LBP that is geographically different from the user's location, or a virtual location based platform LBP.

Moreover, any other suitable type of data transmission is conceivable. The data transmission is preferably effected via a connection which is interrupted after conclusion of the transmission. Consequently, it is not necessary for the user to be continuously “logged on”.

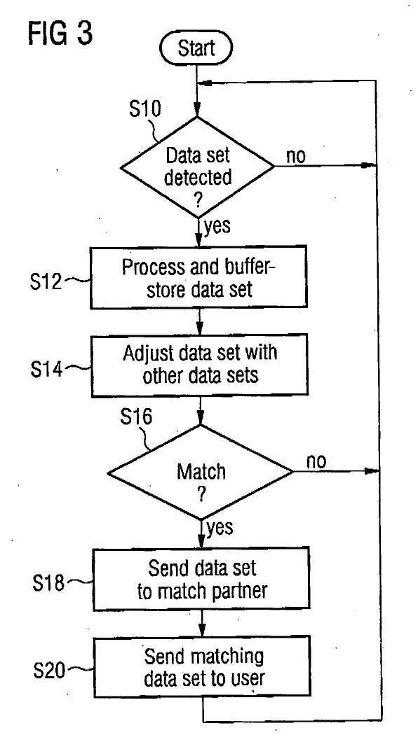

If the data or the data set of the user have (has) been transmitted into the corresponding location based platform LBP, an adjustment process or a match-finding process or a match process is begun in the location based platform LBP and the user's data are adjusted with other users' data that are buffer-stored in the location based platform LBP. The detailed sequence of the method in the location based platform LBP is described below with reference to FIGS. 3 and 4.

FIG. 3 shows the sequence of a method in accordance with a preferred embodiment of the present invention at the server end.

After the start of the method, firstly an interrogation is effected to establish whether a data set or data of a user has (have) been detected by the detection device 20 (step S10). If no data set has been detected (“no” in step S10), the process returns to the initial state. If a data set of a user has been detected (“yes” in step S10), the detected data set is processed and buffer-stored (step S12). It may furthermore be provided that an authentication of the user takes place (not illustrated). The authentication may be effected e.g. by means of a user's mobile radio number.

The detailed sequence of step S12 is described below with reference to FIGS. 3 and 4.

In the detection device 20, it is determined whether the detected data set contains an offer or a search. If the data set contains a search, the data set or that part of the data set which is under consideration is written to the search pool 22. If the data set contains an offer, the data set or that part of the data set which is under consideration is written to the offer pool 24. If it cannot be determined whether a search or an offer is present, the data set or that part of the data set which is under consideration is written both to the search pool 22 and to the offer pool 24.

Moreover, the medium via which the user would like to receive a reply is ascertained in the detection device 20. This may likewise be effected at a later point in time e.g. prior to the communication of data to the user.

Afterward, the data or data sets are read from the pools 22, 24 to lists 26, 28 preferably with the aid of a “grep” command. In this case, searches are written to the search list 26 and offers are written to the offer list 28.

In a further step, the newly added data set is adjusted with other data sets already buffer-stored in the location based platform LBP by the lists 26, 28 being compared with one another (step S14). An interrogation is then effected to establish whether a match is present between the newly added data set and the data sets already buffer-stored in the location based platform LBP. In particular, a check is made to establish whether mutually corresponding offers and searches are present.

Furthermore, the temporal validity of data sets is checked. Data sets whose validity duration has expired are erased.

If a match is not present (“no” in step S16), the process returns to the initial state. If a match, and thus two mutually corresponding data sets of a first user and a second user or two matching partners or match partners, has (have) been found (“yes” in step S16), the data set or a part of the data set of the first user is communicated to the second user (step S18). Afterward, the data set or a part of the data set of the second user is communicated to the first user (step S20). The process then returns again to the initial state.

The communication in steps S18 and S20 is preferably effected by means of unified messaging, in particular SMS, email, fax or the like, and in accordance with the selection of the respective user. Furthermore, the notification or transmission of the data sets may also be effected using large screens.

After receiving the information, the users can decide whether or not they would like to make contact with the respective matching partner.

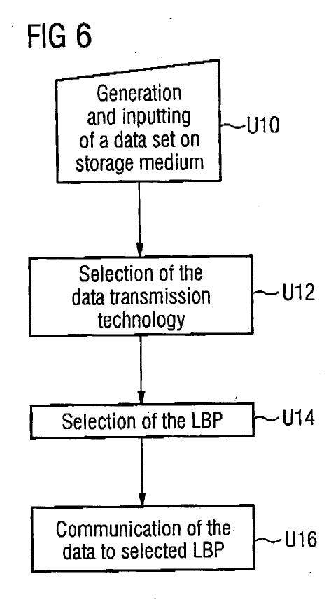

The method described above is described in detail below with reference to FIGS. 6-8.

Firstly, the sequence at the user end of creating and uploading data sets is described with reference to FIG. 6.

In step U10, the data set or the data is (are) created or generated and stored on a storage medium of the user. Afterward, the communication or transmission technology by means of which the user's data are intended to be transmitted to the location based platform LBP is selected by the user (step U12). In this case, the data may be transmitted by means of unified messaging, in particular infrared, fax, SMS, email, Bluetooth, plug-in, feedthrough, TCP/IP or any other desired interface. Afterward, the location based platform LBP to which the data are intended to be communicated is selected in step U14. In step U16, the data are communicated to the selected location based platform LBP. In this case, the communication may be effected immediately or at a later point in time.

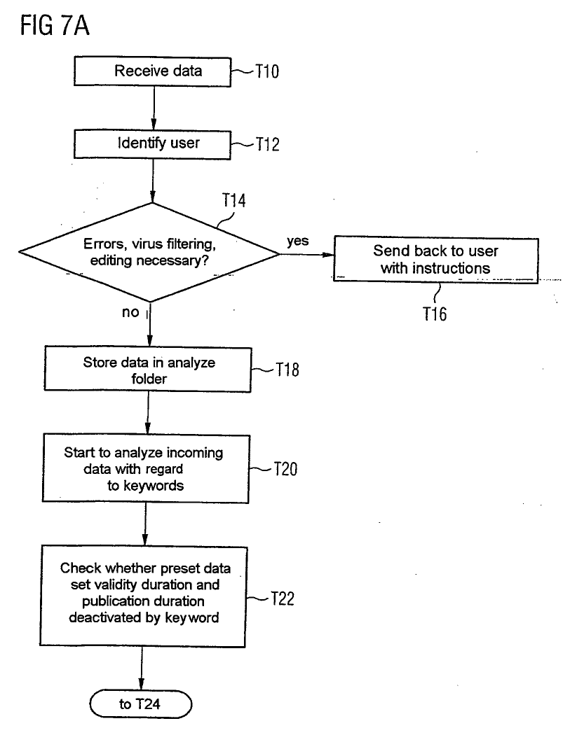

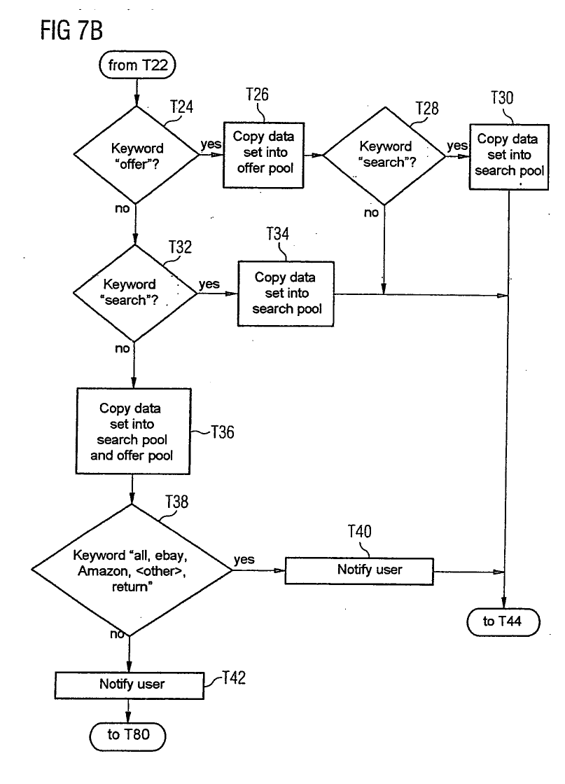

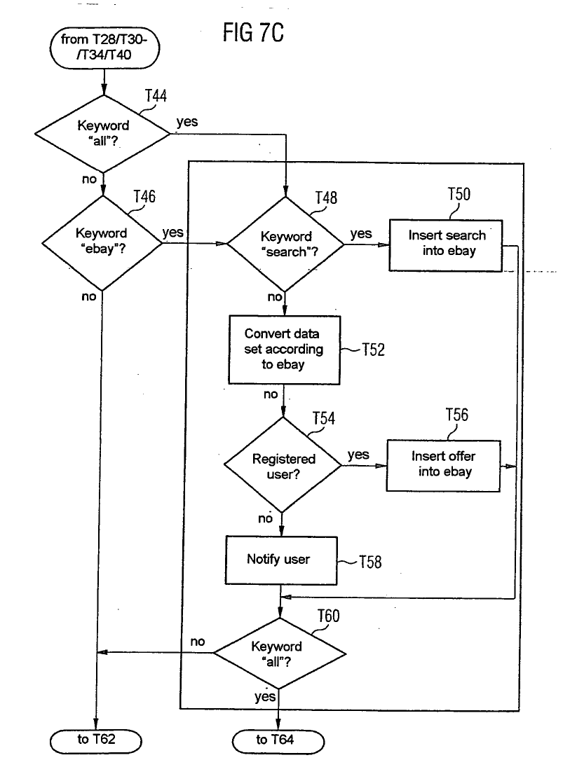

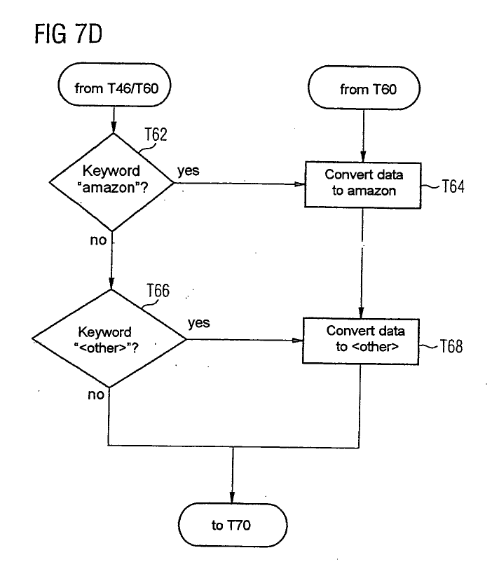

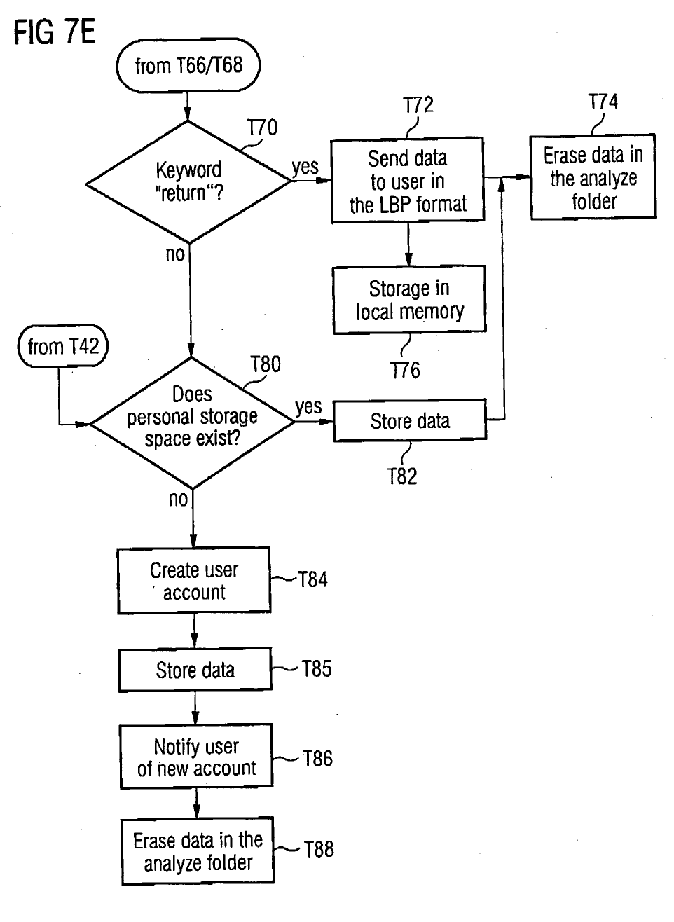

The detailed sequence of the detection and processing of data in a location based platform LBP in accordance with a preferred embodiment of the present invention is described in detail below with reference to FIGS. 7A to 7E. In this case, FIGS. 7A-7E show a flowchart showing the detailed sequence of steps S10 and S12 of FIG. 3.

In step T10, the data of a user are received by the selected location based platform LBP. Afterward, the user is identified and/or authenticated in step T12. This may be effected for example with the aid of the user's telephone number or email address.

In step T14, it is ascertained whether the received data exhibit errors, a virus filtering is effected and/or a check is made to establish whether the data need to be edited. If one of the cases interrogated in step T14 is applicable (“yes” in step T14), in step T16 the data are sent back to the user together with instructions.

If the data do not exhibit errors or if editing is not required (“no” in step T14), the data are stored in a so-called “analyze folder” (step T18).

The data sets stored in the analyze folder are analyzed with regard to predeterminable keywords or a check is made to establish whether predeterminable keywords are present in the data set (step T20).

Afterward, in step T22 it is ascertained whether a system-predefined data validity duration and/or data publication duration in the location based platform LBP is to be deactivated by a predeterminable keyword. By way of example, this may be effected by means of an inputting of the data validity duration by the user as keyword. Furthermore, it may be provided that this possibility of deactivation is only available for predeterminable location based platforms LBP. In the case where this possibility is not available for the location based platform LBP selected by the user, it may be provided that a corresponding notification is communicated to the user (not illustrated).

In step T24, a check is made to establish whether the keyword “offer” is contained in the data set or the data.

If the keyword “offer” is contained in the user's data set (“yes” in step T24), the corresponding data, preferably in unaltered form, are copied into the offer pool 24. Afterward, in step T28 a check is made to establish whether the keyword “search” is contained in the user's data. If the corresponding keyword is contained in the data (“yes” in step T28), the corresponding data, preferably in unaltered form, are copied into the search pool 22 (step T30). In the course of checking whether one of the keywords “search” or “offer” is contained in the data set, it may furthermore be provided that similar or related words or the context are likewise taken into account in the course of checking. Thus, it may e.g. also be recognized from the terms “seek”, “buy”, . . . , that a “search” is involved. A similar situation holds true for the keyword “offer”.

The method subsequently moves to step T44.

If the keyword “offer” is not contained in the data (“no” in step T28), the method moves directly to step T44.

If it has been ascertained in step T24 that the keyword “offer” is not contained in the user's data (“no” in step T24), a check is made in step T32 to establish whether the keyword “search” is contained in the user's data. If the keyword “search” is contained in the user's data (“yes” in step T32), in step T34, in a manner similar to that in step T30, the corresponding data or the data set, preferably in unaltered form, are (is) copied into the search pool 22 and the method moves to step T44.

If the keyword “search” has not been ascertained in step T32 (“no” in step T32), the respective data are copied, preferably in unaltered form, both into the search pool 22 and into the offer pool 24 in step T36.

Afterward, a check may be made (step T38) to establish whether a further predeterminable keyword is contained in the user's data set. This involves in particular the keywords “all”, “ebay”, “Amazon”, “return” . . . The functions allocated to the individual keywords are described later.

If no further keyword has been ascertained in step T38 (“no” in step T38), the method moves to step T42. In step T42, the user is notified that his data have been stored both in the search pool 22 and in the offer pool 24 and that the user had not defined a keyword. Furthermore, the user is informed of the possible keywords that can be specified and the method moves to step T80.

By contrast, if one of the further keywords has been ascertained in step T38 (“yes” in step T38), the user is notified in step T40 that his data have been stored in the search pool 22 and the offer pool 24 and the method proceeds to step T44.

In the steps described below, a description is given of an option of the method in which the detected data or data sets can be used further in a further database system. Such databases may be e.g. ebay, Amazon or the like (identified by “<other>”). If the keyword “all” is contained in the user's data set, the data are used in essentially all databases that are further available in the system.

If the keyword “all” has been ascertained in step T44, that is to say that the data are intended to be introduced into all available databases (“yes” in step T44), the method moves to step T48. If the corresponding keyword has not been ascertained (“no” in step T44), the method moves to step T46, in which a check is made to establish whether the keyword “ebay” has been ascertained. If the keyword “ebay” has been ascertained in step T46 (“yes” in step T46), the method moves to step T48.

In step T48, a check is made to establish whether the keyword “search” has been ascertained in the stored data of the user. In this case, a corresponding keyword may also have been assigned only with the storage of the user's data in the search pool 22 or the offer pool 24 in accordance with the data. This is the case e.g. if the user's data set did indeed contain one of the keywords for one of the further databases but did not contain one of the keywords “search” or “offer”.

If the keyword “search” has been ascertained (“yes” in step T48), the search request or the search is input or inserted at ebay, an online auction provider, in step T50. The method subsequently proceeds to step T60.

If the keyword ”search” has not been ascertained (“no” in step T48), the data set is converted into the ebay format in step T52. It may furthermore be provided that items of information about the external database are extracted prior to conversion.

In the subsequent step T54, a check is made to establish whether the user is a user registered with ebay. If the user is a registered user (“yes” in step T54), the offer is stored at ebay in step T56. The method subsequently moves to step T60.

If the user is not a registered user (“no” in step T54), in step T58 the user is notified that he is not registered with ebay, and that the user consequently cannot use ebay. The method subsequently proceeds to step T60.

In step T60, a check is made to establish whether the keyword “all” is contained in the user's data set. If the keyword “all” has not been ascertained (“no” in step T60), the method moves to step T62. If the corresponding keyword has been ascertained (“yes” in step T60), the method moves to step T64.

In step T62, a check is made to establish whether the keyword “amazon” has been ascertained. This keyword can be used to indicate that the user wishes to use his data set data at Amazon, an online book store. If the keyword “amazon” has been ascertained in step T62 (“yes” in step T62), the method moves to step T64. In step T64, a similar processing to that in steps T48 to T60 is effected, the data being brought to the Amazon format and being stored at Amazon.

Since the processing of the data into the Amazon format is essentially the same as that for the ebay format, a detailed description thereof is dispensed with at this juncture. It should be emphasized, however, that in the event of a check corresponding to step T60 to establish whether the keyword “all” has been ascertained, the method moves from step T64 to step T66 in the event of a negative interrogation result and the method moves from step T64 to step T68 in the event of a positive interrogation result.

If the keyword “amazon” has not been ascertained in step T62 (“no” in step T62), the method moves to step T66, in which it is established whether a further keyword (“<other>”) for a database has been stored. If a corresponding keyword has been stored (“yes” in step T66), a conversion into the corresponding database format in a manner corresponding to steps T48 to T60 is effected in step T68. If the corresponding database is the last database in the list, step T60 is dispensed with. The method subsequently moves to step T70. If the corresponding keyword has not been ascertained in step T66 (“no” in step T66), the method likewise moves to step T70.

In step T70, a check is made to establish whether the keyword “return” is contained in the user's data set. This keyword specifies that the user wishes to send the transmitted data back in the format conditioned for the location based platform LBP. If the corresponding keyword has been ascertained in step T70 (“yes” in step T70), the data are sent back to the user in step T72. Afterward, in step T74, the data are erased from the analyze folder which is a temporary storage space for the data prior to division into the search pool and offer pool.

T76 represents the storage, at the user end, of the data communicated in step T72 on a USB memory stick, a memory card or a PDA.

If the user had not inserted the keyword “return” into his data set (“no” in step T70), a check is made to establish whether a personal storage space allocated to the user exists on the Internet (step T80). If such a personal storage space does exist (“yes” in step T80), the data are stored in the corresponding storage space (step T82) and the method moves to step T74. If a corresponding storage space does not exist (“no” in step T80), a corresponding user account or a storage space that is unambiguously allocated to the user is generated or created in step T84. Afterward, the data are stored in the newly generated storage space (T85) and the user is informed of the new storage space in step T86. Afterward, in a manner similar to that in step T74, the data are erased from the analyze folder in step T88. As described above, the data are stored by default on the Internet unless specified otherwise by the user. As an alternative, it may be provided that the data are sent back to the user or discarded by default, preferably by the user.

After the steps described above have been carried out, the data communicated by a user are ready in the selected location based platform and an adjustment of data sets can be carried out.

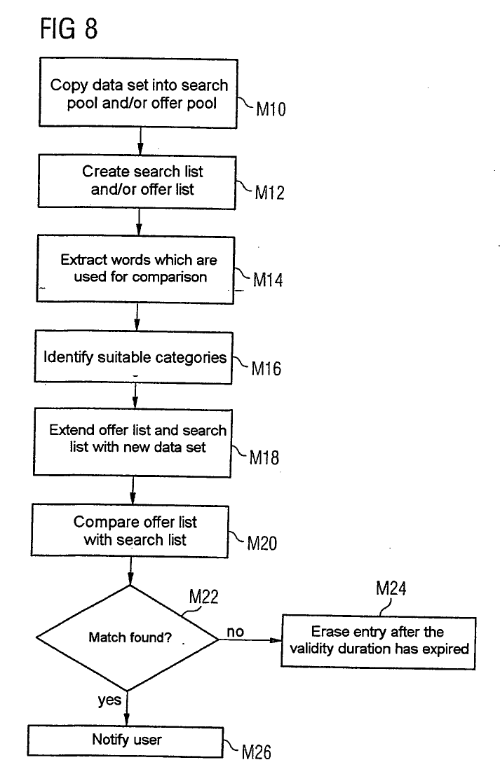

A detailed description is given below of the adjustment and communication of data sets to match partners with reference to FIG. 8. In particular, the flowchart in FIG. 8 shows in detail a sequence corresponding to steps S14 to S20 of FIG. 3.

The process of adjustment is started by the copying of data into the search pool 22 and/or the offer pool 24 in steps T26, T30, T34 and T36 (step M10). This means that as soon as a new data set or a part of a newly received data set is copied into the search pool 22 and/or the offer pool 24, an adjustment is started.

Afterward, in step M12, a search list 26 and/or an offer list 28 is created from the search pool 22 and/or offer pool 24. If the data have been input via the input mask described with reference to FIGS. 2A to G, the data are already present in the required format, preferably HTML format, and can be directly processed further. If the data have been communicated as non-dedicated data, e.g. in the form of a Microsoft Word or Excel file, these non-dedicated data are brought to the HTML format (Hypertext Markup Language Format). In particular, the data are retained in the non-dedicated format and merely a representation in the HTML format is effected in order to enable further processing. Consequently, essentially a copy of the non-dedicated data is created in an HTML representation and processed further. The HTML format is mentioned here only as an example. It is possible to use any other suitable format.

The data in the HTML format are processed further in step M14. In this case, e.g. predetermined HTML identifiers or HTML tags are removed, keywords are ascertained, e.g. nouns and verbs are extracted, and a grammatical processing is effected. In this case, the keywords are ascertained from the non-dedicated data in particular with the aid of a “grep” command.

Afterward, in step M16, suitable categories are ascertained in order to harmonize identical or similar words. By way of example, the English words “automobile” and “car” are marked as equivalent.

In step M18, the data thus obtained are inserted into the search list 26 and the offer list 28. In addition, the newly inserted data object is provided with an identification number, a category, a list of search or matching terms, a time stamp and the like. The search list 26 and the offer list 28 are preferably lists in the ASCII format, which enables a simple adjustment of the lists.

Afterward, the content of the search list 26 is compared with the content of the offer list 28 with the aid of corresponding search and adjustment routines in step M20.

In the subsequent step M22, a check is made to establish whether a match has been found. If no match has been found (“no” in step M20), in step M24 the corresponding data object is erased after the validity duration has expired.

If a match has been found in step M22 (“yes” in step M22), the respective match partners or users whose data sets, at least in part, match or correspond to one another are notified in step M26. In particular, at least a part of the data set of the respective other match partner is communicated to the match partner. This communication is effected by means of unified messaging, e.g. email, SMS, fax or the like. In particular, at least one data set identification number of the data set of the match partner, contact data of the match partner (e.g. the telephone number), the keyword that led to a match is communicated to the user. The match percentage may optionally be communicated. Generally, the communication is effected in the same way as the user had communicated his enquiry to the location based platform. By way of example, if a user had sent his enquiry by SMS, the adjustment result is communicated to him by SMS. However, as already described, the user can choose a different type of result communication. In particular, it may be provided that the connection via which the result is transmitted is interrupted after the end of the transmission.

Furthermore, it may be provided that the content of the communicated data set varies depending on the type of result communication. Thus, by way of example, it may be provided that the user, in the case of an email communication, is communicated the entire document or the entire data set of the match partner, whereas only a part of the data set and thus a smaller quantity of data is communicated in the case of a communication by SMS or infrared.

Consequently, the method and system described above can be used to make it possible to ascertain two users with matching or complementary requirements and to exchange data sets between these users.

Furthermore, it may be provided that the data of a user, in a similar manner to that described in steps T48-T60, are used in an external database, such as e.g. ebay, Amazon etc. In this case, it is possible to use in particular the data stored in the storage space on the Internet that is allocated to a user and/or the data stored on a storage medium or computer of the user. For this purpose, firstly a connection to the storage space of the data is set up or produced (step P10). By way of example, it is possible to produce a connection via the Internet to the storage space allocated to the user, to connect the storage medium to a reader or to make a corresponding selection on the user's computer.

In step P12, the content is read from the user's storage space and, in step P14, a check is made to establish whether a data object or data set is available, i.e. whether data are stored in the storage space. If no data objects are available (“no” in step P14), the user can generate data objects in step P16. This may be effected for example by means of the user interface shown in FIGS. 2A to 2G. The data objects are stored at a storage location (personal storage space on the Internet, storage medium, computer, . . . ) in accordance with the user's selection and the method subsequently proceeds to step P10.

If it has been ascertained in step P14 that data objects are available (“yes” in step P14), in step P18 a check is made to establish whether the format of the database to which the data or data objects of the user are intended to be written is known. If the database format is known (“yes” in step P18), the data objects are stored in the known database format on the user's computer (step P20) and the method proceeds to step P22. In particular, for this purpose it is possible to use an external tool that effects the conversion of the data format locally on the user's computer.

If the external database format is not known (“no” in step P18), in step P24 the data objects are stored on the user's computer in a predetermined format provided for editing. Afterward, the user may correspondingly edit the data such that they correspond to the data format of the respective database. The method subsequently moves to step P22.

In step P22, the locally stored data objects are imported into the external database using an application which is assigned to the external database and which is preferably stored on the user's computer and is executed there. Afterward, in step P24, data objects are written to the external database and are available there for further processing.

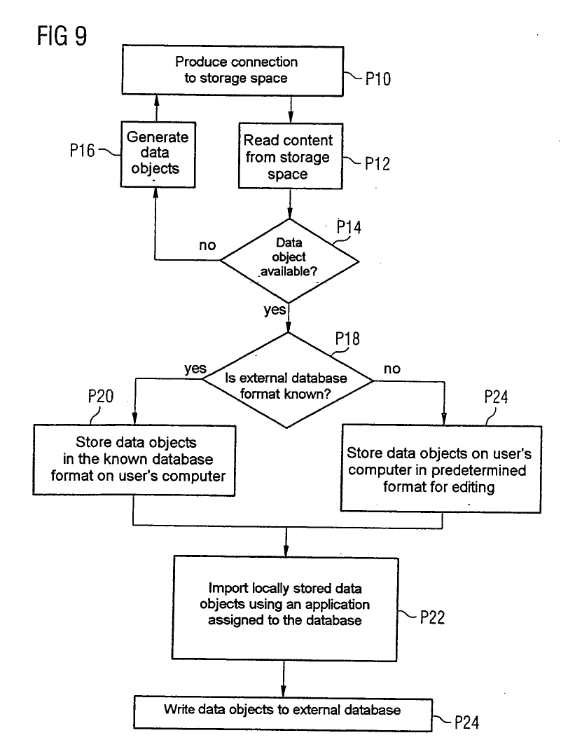

In addition or as an alternative, it may be provided that data which have already been stored in an external database by the user are imported into the system described above. In this case, provision is made of a processing which corresponds to the processing described with reference to FIG. 9 and which converts the data format of the external database into the format of the present system.

Already existing mobile radio cells or an already existing mobile radio system can be used as geographical areas for the location based platform LBP. Furthermore, it is also possible, however, to provide an autonomous system.

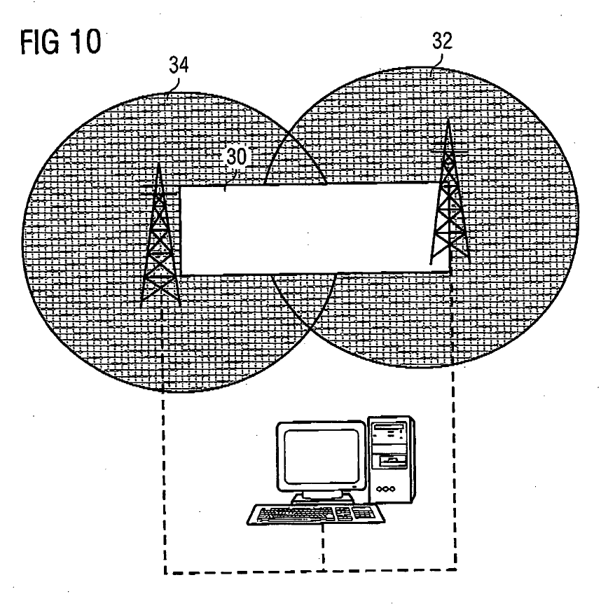

FIG. 10 shows a preferred possibility as to how a geographical area can be defined with the aid of mobile radio cells.

A predetermined geographical area (defined by a user) is marked with the reference symbol 30. The area 30 is situated in an area covered by the mobile radio cells 32 and 34. The predetermined area 30 can be approximated with the aid of the area covered by the mobile radio cells 32 and 34. It may be provided that data are transmitted to a location based platform LBP if the user is situated within the area covered by the mobile radio cells 32 and 34. Although the area covered by the mobile radio cells 32 and 34 is larger than the predetermined area 30, this inaccuracy can be disregarded in most cases.

A predetermined geographical area can thus be defined in a simple manner using the already existing mobile radio network infrastructure.

Moreover, it is conceivable for the user to transmit the data in the form of a file. This may be for example a Microsoft Powerpoint file, Microsoft Excel file or Microsoft Word file. Such data are, in particular, non-dedicated data. The data are then extracted from the file by the system and assigned in the manner described above.

It may be provided that the location based platform LBP is operated on a server computer. As an alternative, it may be provided that the location based platform LBP is operated on a mobile device assigned to an operator and/or user, such as e.g. a mobile phone or PDA (Personal Digital Assistant). In this case, the data sets are preferably transmitted by SMS. Furthermore, it is not necessary for the location based platform LBP to have a connection to the Internet.

Preferably, the data or data sets are stored in the location based platform LBP only over the time duration of the validity of the data or are available there only temporarily. Furthermore, it may be provided that the data that are buffer-stored in a location based platform LBP are lost when the system is switched off and, consequently, are available only during operation of the system.

Consequently, with the aid of the method described above, it is possible to adjust electronic user data or data sets or classified advertisements, stored on a standalone storage medium or memory chip, between the users of the storage media. In particular, the data sets can be created electronically by the users, and subsequently be edited. The subsequent editing process is preferably effected analogously to a retrieval and discarding of an already sent message, as is known e.g. from a Microsoft Exchange mail server. In particular, a data set which has not yet been transmitted to another user can be retrieved from the respective location based platform LBP and/or be erased from the latter and a changed data set can be communicated to the location based platform LBP.

The user can input his data or data sets in a simple manner with the aid of the method described above. In particular, the data inputting can be effected by means of an input mask familiar to the user. Since the user's data are stored on the user's storage medium which can only be accessed by the user and are buffer-stored in the location based platform only over a determined or determinable time duration, the data security can be increased or the possibility of data misuse can be reduced.

The method described above can be used to effect a temporal decoupling of steps (a) creation and editing of the data set by a user, (b) further processing and adjustment of the data sets in the location based platform and (c) sending and result notification by the location based platform. Furthermore, it becomes possible to make available data sets of a location-related target group or a preselectable population.

In particular, the method described above provides for the original information or the original data set to remain with the sending user and for a copy to be transmitted via the various communication paths. The copy is evaluated in the location based platform LBP. Afterward, the data or at least a part of the data set are (is) communicated to a plurality of interested parties who are not already known to the sender in the sense of a predefined email distribution list, but rather are only ascertained anew and preferably separately on the basis of the evaluation for each data set. In particular, the data transmission is not effected to a dedicated receiver or in particular receiver predetermined by the user, but rather to further users of the system who are generally not known to the user.

Examples of the application of the system and method described above are given below.

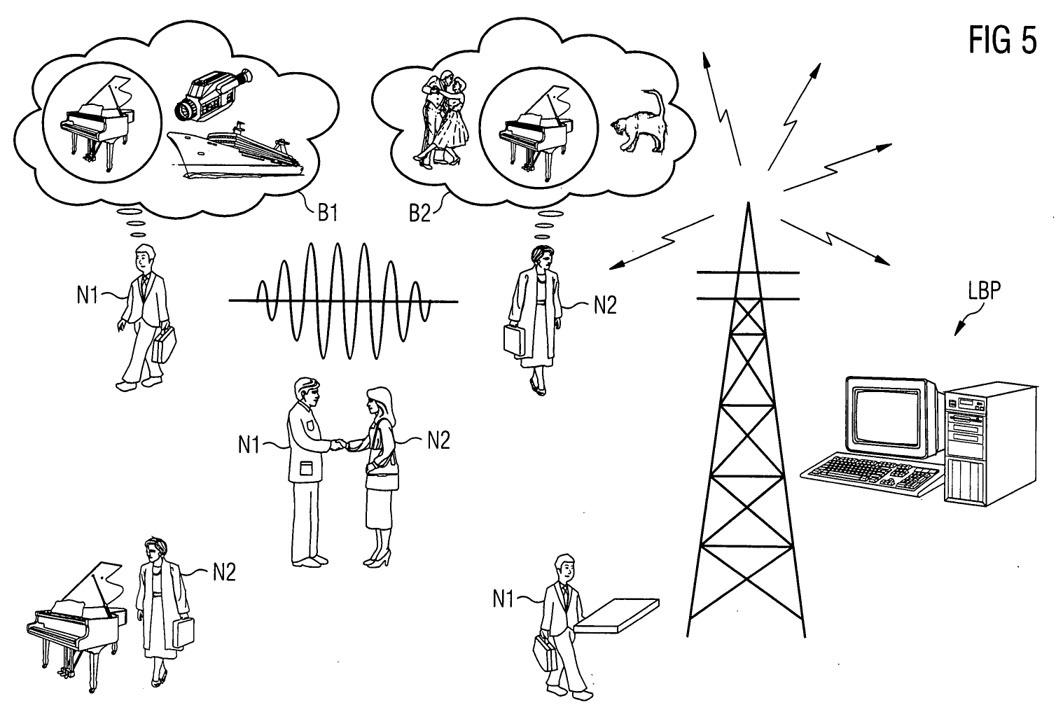

FIG. 5 shows an exemplary scenario for the purchase of a product.

Two users N1, N2 each have a range of interests that are illustrated diagrammatically in the areas B1 and B2. The user N1 is interested for example in cruises, video cameras, and would like to sell a piano. The user N2, on the other hand, is interested in dance, cats, and would like to buy a piano.

These interests of the users N1 and N2 are transmitted as offers and searches to a location based platform LBP encompassing a predetermined geographical zone. In the present example, the transmission is in each case effected by means of a mobile telephone if the respective user enters the geographical zone or the mobile radio cell which covers said geographical zone.

In the location based platform LBP, the data sets of the users N1 and N2 are adjusted with one another and a match is found in the fact that the user N1 would like to sell a piano and the user N2 would like to buy a piano. The users N1 and N2 are informed of the respective corresponding partner sharing an interest by virtue of at least a part of the data set of the respective other partner sharing an interest being transmitted to the respective users N1 and N2. By way of example, in this case it is possible to transmit the telephone number of the respective other user and the matching part of the data set, i.e. data with regard to the purchase/sale of a piano. Afterward, the users N1 and N2 can make contact with one another and handle the transaction concerning the purchase of the piano.

Further application possibilities are described below.

A user situated in a town A is searching for a dwelling in town B. The user communicates his dwelling search e.g. by email or SMS to a location based platform in town B. Afterward, an adjustment takes place in the location based platform in town B and, in the case of a matching result, a data set of a dwelling provider in town B is communicated to the user.

A person A is searching for a used car near to his locality and communicates his purchase search e.g. by email or SMS to a location based platform that covers a specific area in his place of residence. Afterward, an adjustment takes place within the selected location based platform in town A, and in the case of a matching result, a data set of an automobile provider B is communicated to person A. In addition, person B receives a data set concerning the purchase desire of person A.

In the context of the offer by Deutsche Bundesbahn to transport up to 5 persons for 28 euros at weekends, it is often the case that the maximum number of permitted travelers is not fully utilized. The present invention makes it possible for travelers, by means of communicating their travel destination to a location based platform situated at the railroad station, to find fellow passengers and share the journey costs before the train departs.

The invention may furthermore also be used in a mass transportation means, such as e.g. a train. In this case, provision may be made e.g. of a display and a keyboard in the seats by means of which a user can input an offer or a search. Furthermore, individual passengers can be identified and localized by the seat number of their seat.

There are in-house sales offices for a company's employees. Using the present invention it is conceivable for particular offers to be communicated to employees by such sales offices when the employees enter company grounds or use their pass for time and attendance recording. Furthermore, it is conceivable that employees can define specific preferences or products or product groups with regard to which they would like to receive offers.

Furthermore, it is conceivable to construct a network within a predetermined circle, e.g. in a company, in order e.g. to exchange knowledge between persons in this circle (the company's employees). In this case, one person may send particular competences as an “offer” to a location based platform. If another person searches for information about said particular competences, he may accordingly send a “search” to the location based platform.

A further application relates to the distribution of information and documents at conferences or other events. A participant may e.g. receive the available documents on a specific subject by means of search enquiry (SMS, email, etc.) to the location based platform. In this case, he can have either a list of the documents or the associated files themselves transmitted to his storage medium. It is also possible, of course, in this way to make contact with other specialists through the offer/demand adjustment since the provider may in turn be informed of who is interested in the items of information/files that he is offering.

Moreover, it may be provided that the storage medium of a user forms part of a bonus program or system e.g. of an airline. In this case, both user-specific data, such as e.g. seat and/or menu preferences, etc., and general information data from the airline for the user, such as e.g. the flight schedule or information about connecting flights, can be stored on the storage medium. It may furthermore be provided that an electronic ticket may be stored on the storage medium. By reading from the user's storage medium, it is possible to effect detection of the user and his preferences. Furthermore, the user may e.g. be informed of delays or changes to travel plans. Moreover, it may be provided that third parties can obtain information about the itinerary or the instantaneous location of the user.

In particular, the following sequence may be provided: the user logs on to the airline's Internet page in order to book a flight. In addition to the desired flight data, the data stored on the user's storage medium are transmitted to the airline. Consequently, user-specific information can be transmitted. The flight ticket is stored on the user's storage medium and the user can check in using the storage medium. On the airplane, the user can be identified e.g. by the seat number. By reading from the user's storage medium and acquiring the data stored thereon, the crew receives information about the user's preferences in a simple manner and can devote attention thereto.

The above-described system can also be employed in other mass transportation means, such as e.g. trains or buses.

In a further application, it may be provided that patient data, such as e.g. the medical history, health insurance information, . . . , are stored on a storage medium. Upon entry to a hospital or a physician's practice, these data can be read out and are available to the physician.

The system described above can furthermore be used for tracking persons or objects. By way of example, it is possible to detect a data set if a first user moves into a predeterminable area, e.g. a building. A second user can then send a data set to the respective location based platform LBP assigned to the predetermined area in order to interrogate whether the first user is situated in the specific location based platform LBP. By way of example, it is thus possible for parents to check whether their child is at the kindergarten or school. Furthermore, it may be provided that a data set is detected if the first user leaves the predetermined area. In this case, the data set communicated upon entry to the area can be erased from the location based platform LBP and/or the newly communicated data set can be transmitted to a second user in order to signal to the latter that the first user has left the predetermined area. Moreover, it may be provided that a predeterminable identification is agreed between users of a predetermined group, which identification is taken into account during the adjustment process in the location based platform LBP. What can thereby be achieved is that the transmitted items of information are available only to the users of the respective group. Furthermore, the data sets detected by the first user can be stored in a central location, so that the first user's whereabouts can be tracked.

1. A method for selectively communicating data sets, comprising the steps of:
detecting at least one data set of a first user, the data set being communicated via an at least unidirectional connection;
detecting at least one data set of at least one second user;
comparing at least one part of each of the detected data sets; and
if a matching result is determined, further comprising at least one of the following steps:
communicating at least one part of the at least one data set of the first user to the at least one second user; and
communicating at least one part of the at least one data set of the at least one second user to the first user.

2. The method as claimed in claim 1, further comprising the step of buffer storing the detected data sets.

3. The method as claimed in claim 1, further comprising the step of processing the detected data sets.

4. The method as claimed in claim 3, wherein the detected data sets comprise non-dedicated and/or non-structured data.

5. The method as claimed in claim 4, wherein the non-dedicated and/or non-structured data sets are represented in ASCII format for the comparing step.

6. The method as claimed in claim 1, wherein the steps of communicating the data sets to the users are effected by means of unified messaging.

7. The method as claimed in claim 6, further comprising the step of ascertaining a medium via which a data set is communicated to a specific user.

8. The method as claimed in claim 1, wherein the detected data sets have a temporally limited validity, and the method further comprises the step of checking the validity of the data sets.

9. The method as claimed in claim 1, further comprising the step of, after conclusion of the communication, interrupting the connection via which the at least one data set of the first user is communicated.

10. The method as claimed in claim 1, wherein the at least one data set of the at least one second user is communicated via an at least unidirectional connection which is preferably interrupted after conclusion of the communication.

11. The method as claimed in claim 1, wherein the communication of the at least one part of the at least one data set of the first user to the second user is effected via an at least unidirectional connection which is preferably interrupted after conclusion of the communication.

12. The method as claimed in claim 1, wherein the communication of the at least one part of the at least one data set of the at least one second user to the first user is effected via an at least unidirectional connection which is preferably interrupted after conclusion of the communication.

13. The method as claimed in claim 1, wherein at least one of the steps of detecting data sets comprises a step of detecting data sets of users from a geographically and/or virtually delimited area.

14. The method as claimed in claim 13, further comprising the step of determining the geographically delimited area with aid of mobile radio cells.

15. The method as claimed in claim 1, wherein at least one of the steps of detecting data sets comprises a step of reading-out from a storage medium of a user.

16. The method as claimed in claim 15, wherein the storage medium is a mobile storage medium.

17. The method as claimed in claim 1, wherein at least one of the detecting steps comprises the step of categorizing at least one part of the detected data set.

18. The method as claimed in claim 1, wherein at least one of the detecting steps comprises the step of identifying and/or authenticating the user.

19. The method as claimed in claim 1, further comprising the step of communicating at least one part of the at least one data set of at least one of the users to an external database.

20. The method as claimed in claim 1, further comprising the step of storing at least one part of the at least one data set of at least one of the users in a storage space that is unambiguously allocated to the user.

21. The method as claimed in claim 1, wherein at least one of the detecting steps is effected if the user enters a predetermined area.

22. The method as claimed in claim 1, wherein at least one of the detecting steps is effected if the user leaves a predetermined area.

23. A computer program for selectively communicating data sets, which have program parts for carrying out the method as claimed in claim 1.

24. An apparatus for selectively communicating data sets, comprising:
a detection device for detecting at least one data set of a first user and at least one data set of a second user;
a comparing device for comparing at least one part of each of the detected data sets; and
a communication device for communicating at least one part of each of the data sets to the users, the communication device being designed such that, if a matching result is determined, the communication device communicates at least one part of the at least one data set of the first user to the second user, and/or communicates at least one part of the at least one data set of the second user to the first user.

25. The apparatus as claimed in claim 24, further comprising a storage device for buffer storing the detected data sets.

26. The apparatus as claimed in claim 24, further comprising a processing device for processing the detected data sets.

27. The apparatus as claimed in claim 24, wherein the communication device is designed for communicating the data sets by means of unified messaging.

28. The apparatus as claimed in claim 24, further comprising a device for ascertaining a medium via which data sets are intended to be communicated to a specific user.

29. The apparatus as claimed in claim 24, further comprising a device for checking validity of a data set.

30. A system for selectively communicating data sets, comprising:
an apparatus as claimed in claim 24; and
at least two storage media on which data sets are stored and/or edited by the users;
wherein the data sets are in each case communicated from a storage medium to the apparatus.

31. The use of a system as claimed in claim 30 for distribution of documents on an event.

32. The use of a system as claimed in claim 30 for distribution of information in a network of persons.

33. The use of a system as claimed in claim 30 for communication between persons in a mass transportation means.

34. The use of a system as claimed in claim 30 for establishing whether a user is situated in a predetermined area.

35. A method for selectively communicating data sets, comprising the steps of:
making a data set available to a locally or virtually delimited platform by each of a first and a second user;
comparing the data sets of the users in the platform; and
if a matching result is determined, further comprising at least one of the following steps:
communicating at least one part of the data set of the first user to the second user; and
communicating at least one part of the data set of the second user to the first user.
